(19) United States
(12) Patent Application Publication
(10) Pub. No.: US 2024/0344897 A1
(43) Pub. Date: Oct. 17, 2024

(54) NTC SENSOR AND METHOD OF MANUFACTURING AN NTC SENSOR

(71) Applicant: TDK Electronics AG, München (DE)

(72) Inventors: Jan Ihle, Raaba-Grambach (AT); Elisabeth Schwarz-Funder, Hart Bei Graz (AT); Wolfgang Fail, Wies (AT); Gerhard Hojas, Söding-St. Johann (AT); Subramanian Ravichandran, Deutschlandsberg (AT); Dhananjay Chavan, Berlin (DE)

(21) Appl. No.: 18/579,477

(22) PCT Filed: Jul. 4, 2022
(86) PCT No.: PCT/EP2022/068430

§ 371 Date: Jan. 15, 2024

(30) Foreign Application Priority Data
Jul. 19, 2021 (DE) 10 2021 118 569.6

(51) Int. Cl. G01K 7/22

(52) U.S. Cl. CPC G01K 7/22

(57) ABSTRACT

In an embodiment a NTC sensor include a chip, two parallel wires, each wire having contact points, and contact-connections between the chip and the contact points of each of the wires, wherein a maximum lateral dimension of the NTC sensor in any direction perpendicular to a direction of extension of the wires is equal to or less than a sum of the lateral dimensions of the chip and the wires.

### CROSS-REFERENCE TO RELATED APPLICATIONS

This patent application is a national phase filing under section 371 of PCT/EP2022/068430, filed Jul. 4, 2022, which claims the priority of German patent application 102021118569.6, filed Jul. 19, 2021, each of which is incorporated herein by reference in its entirety.

### TECHNICAL FIELD

The present invention relates to an NTC sensor and a method for manufacturing NTC sensors.

### BACKGROUND

Previously available NTC thermistor temperature sensors with a plastic coating are manufactured using conventional assembly and coating technologies.

The electrical resistance of an NTC thermistor ceramic changes with changing temperatures. In particular, the resistance of the NTC thermistor decreases with increasing temperatures. NTC stands for Negative Temperature Coefficient. NTC thermistors are also known as thermistors.

The NTC thermistor ceramic is integrated into a circuit via connecting wires. The temperature of the NTC thermistor can therefore be measured indirectly via the change in resistance in the circuit. As the temperature of the NTC thermistor usually depends on the ambient temperature, the ambient temperature can also be measured in this way. A plastic housing can protect the thermistor from environmental influences, but should have good thermal conductivity to enable the ambient temperature to be measured.

Examples of NTC thermistor elements are known from the document DE 10 2005 017 816 A1.

### SUMMARY

Embodiments improve the known NTC sensors and methods for manufacturing NTC sensors.

The NTC sensor comprises a chip, two parallel wires, each of which has contact points, and contacts between the chip and the contact points of each of the wires.

A maximum lateral dimension of the NTC sensor in any direction perpendicular to the direction in which the wires extend is equal to or less than the sum of the lateral dimensions of the chip and the wires.

The direction in which the wires run is referred to as the direction of extension. The wires are arranged parallel to each other and preferably in a straight line.

The wires can have insulating sheaths. The wires can be directly adjacent to each other or spaced apart. They can be two single wires or a double wire in which the insulating sheaths of two wires are directly connected.

The wires have contact points where the electrically conductive wires have no insulating sheathing. These can be, for example, the wire ends or points on the sides of the wires where the insulating sheathing has been deliberately removed.

The chips are arranged at the contact points of the wires. The chip can be arranged in such a way that the maximum dimension of the chip is perpendicular to the direction in which the wires extend. This arrangement is achieved by forming the two contact points next to each other on two parallel wires.

Both mechanical connections and electrical contacts are formed between the chip and the wires.

Preferably, the chip has external electrodes for electrical contacting, which are connected to the wires. The connection or contact between the chip and the wires is made either by soldering or by applying a conductive adhesive.

As described above, the maximum lateral dimension of the NTC sensor in any direction is equal to or less than the sum of the lateral dimensions of the chip and the wires.

A lateral dimension is any dimension of the NTC sensor in a direction perpendicular to the direction in which the two parallel wires extend.

Due to targeted contacting with small amounts of contacting material such as solder or adhesive and an advantageous arrangement of the chip on the wires, the external dimensions of the NTC chip can be reduced as described. One of the advantages of this is that the NTC sensor can be easily inserted into assemblies with small dimensions through small insertion channels.

In particular, the exposed path between the outside of an assembly and the point in the assembly where the sensor is to be installed is referred to as the insertion channel. The dimensions of the exposed cross-section of the insertion channel can therefore be very small. The entire assembly can be designed to be as small as possible, which reduces space and costs.

According to one embodiment, the maximum lateral dimension of the NTC sensor is not larger or only slightly larger than a lateral dimension of the chip in the same direction.

This can be achieved by an advantageous arrangement of the chip on the wires. Furthermore, this can be achieved by advantageous contacting with small amounts of contacting material such as solder or adhesive.

In this embodiment, the chip is the limiting component when inserting the NTC sensor through an insertion channel into its installation position in an assembly. If the chip is designed with the smallest possible dimensions, the size of the NTC sensor can also be minimized.

In one embodiment, the lateral dimension of the chip in any direction perpendicular to the direction in which the wires extend is not greater than the dimension of the two wires in the same direction.

Thus, in the direction in which the two wires lie next to each other, the dimension of the chip is not greater than the sum of the diameters of the wires. The wires are preferably directly adjacent to each other, so that the dimension of the NTC sensor in the lateral direction is not larger than the dimension of the chip.

In the direction perpendicular to this, in which the wires are not next to each other, the lateral dimension of the chip is not larger than the diameter of one of the wires.

The wires preferably have the same diameter in all embodiments.

In one embodiment, the lateral dimension of the chip in any direction perpendicular to the direction in which the wires extend is less than the dimension of the two wires in the same direction.

The diameters of the wires are measured including any insulating sheathing.

The maximum dimension of the chip is not greater than the sum of the diameters of the two wires. Thus, a sensor head comprising the chip with the applied wires has a dimension that preferably hardly differs from the dimensions of the other sections of the wires. The sensor head is usually the section of the sensor with the widest dimensions. The described sensor with a very small sensor head can therefore also be easily installed in very small assemblies into which the wires can be inserted through channels, such as in batteries.

In one embodiment, the chip has a maximum dimension of 0.6 mm.

A typical dimension of the wires with surrounding sheathing is 0.3 mm. Two wires lying directly next to each other or a double wire therefore have a width of 0.6 mm. If the chip is attached to the ends of the wires with a maximum extension of 0.6 mm and the chip is suitably oriented, this ensures that the chip does not protrude laterally beyond the wires. The sensor head therefore has hardly any or only slightly larger dimensions than the wires.

In the case of wires with smaller or larger diameters, the chip can have correspondingly smaller or larger dimensions, whereby the dimensional ratio between chip and wires should be maintained.

The chip is preferably rectangular in shape. The maximum expansion of the chip is 0.6 mm. The maximum expansion of the chip in a lateral direction perpendicular to the maximum expansion direction is 0.3 mm. If the chip is attached in a suitable orientation to the head end of two adjacent wires with a diameter of 0.3 mm each, the chip does not protrude laterally beyond the wires.

The expansion of the chip along a third direction, which is perpendicular to the contact surface between the chip and the wires, i.e. along the direction in which the wires extend, can be variable, but preferably has a maximum expansion of 0.33 mm.

In one embodiment, the chip is a ceramic multilayer component with internal electrodes.

The multilayer component consists of several NTC thermistor ceramic layers between which metallic inner electrodes are provided. The electrical resistance of such a multilayer component can be defined very precisely. Resistance tolerances of less than 1% can be achieved.

The resistance of the NTC material depends on the temperature. At higher temperatures, the resistance decreases (hot conductor). The behavior of the resistance as a function of temperature is represented by resistance-temperature curves. The resistance tolerance can be set for a nominal temperature so that it does not exceed a value of 1%.

In the embodiment described, the inner electrodes can be electrically contacted by outer electrodes on the surfaces of the chip. The outer electrodes are preferably applied to two opposite side surfaces of the chip. The outer electrodes can be cap-shaped and cover different side surfaces of the chip. Preferably, the inner electrodes stacked in the multilayer component are alternately connected to the two oppositely positioned outer electrodes.

The outer electrodes comprise metallization layers made of silver, for example, which are applied using an immersion process with subsequent baking. In addition, Ni—Sn (nickel-tin) layers can be applied by electroplating. The Ni—Sn layers are preferably applied to the outside of the silver metallization layers.

According to a further embodiment, the chip comprises a monolithic NTC thermistor ceramic. The ceramic in the chip can therefore be formed as a continuous monolith. No other components such as internal electrodes are present within the ceramic. Such a chip can be provided very easily. External electrodes are provided on two opposite surfaces for contacting the chip.

In one embodiment, the two wires are arranged in parallel and preferably run in a straight line next to each other.

In the case of sheathed wires, the insulating sheaths of the wires can lie directly against each other.

Wires adjacent to each other require less space than spaced wires when installed in an electronic assembly. The chip with the dimensions described above can be easily contacted by two wires lying next to each other.

In a preferred embodiment, the wires are not two individual wires, but a double wire in which the sheaths of the two wires are firmly connected. Such a double wire is easier to handle in the manufacturing process than single wires.

In one embodiment, the end faces of the wires act as contact points on which the chip is placed.

The end faces of the wires can be designed as blunt ends of the wires. A blunt end is created, for example, when a wire is cut at right angles to its longitudinal direction. At this blunt end, the metallic, electrically conductive wire is exposed from the insulating sheathing.

If necessary, the sheathing around the end faces at the wire ends can be removed further. The coating can be removed by mechanical cutting or laser ablation, for example.

If the chip, whose dimensions do not or only barely exceed those of the wires, which are still preferably arranged parallel to each other, is applied directly to the end faces of the wires, the chip does not or only barely protrude laterally beyond the wires. The chip is then virtually an extension of the wires with similar dimensions to the wires. The dimensions of the sensor head, i.e. the chip with the wires attached to it, therefore correspond approximately to the dimensions of the chip. This means that the sensor head can simply be inserted into an assembly together with the wires.

In one embodiment, the contact points are L-shaped, with the chip being placed on the L-shaped contact points.

Preferably, the end faces of the wires act as contact points, which are then L-shaped. For this purpose, the blunt ends of the wires described above can be partially flattened so that the end has a blade shape.

The dimensions of each wire in the flattened direction are negligible compared to the diameter of the wire. The flattened side surfaces of the wire are shaped similar to shovel blades.

The blade-shaped surface provides a large contact area that can be attached to the chip. This creates a stable and secure connection and electrical contact with low connection resistance between the chip and the wires.

In particular, the L-shaped surfaces of two wires—shaped like a blade—can be attached to two opposing outer surfaces of the chip. This allows the chip to be positioned between the wires, which further increases the stability of the sensor.

Due to the flattening of the wire, the dimensions of the sensor head also correspond approximately to the dimensions of the chip in this embodiment. With suitably selected chip dimensions, the sensor head does not protrude or hardly protrudes laterally beyond the wires and thus forms a quasi-extension of the wires with similar dimensions. The sensor head can therefore simply be inserted into an assembly with the wires.

In one embodiment, the contact points are formed by exposing sections of the wire provided for this purpose from an insulating sheath.

In one embodiment, the connection between the chip and the wires is made by soldering.

In one embodiment, the contacts are formed using the smallest possible amount of solder.

In one embodiment, the heat required for soldering is provided by the self-heating of the NTC thermistor ceramic when an electrical voltage is applied.

Solder paste is applied to the ends of the wires to which the chip is to be soldered. The solder paste can consist of various metals such as lead, tin, zinc, silver, copper, gold, antimony and bismuth. Preferably, the solder paste can be lead-free. Furthermore, the solder paste can be impregnated with a flux.

The chip can then be positioned in a carrier between the wire ends that have been coated with solder paste. An electrical voltage is applied via the wires. Applying the electrical voltage heats up the NTC thermistor ceramic of the chip.

The self-heating of the chip causes the solder paste to melt and solidify during subsequent cooling. A soldered contact is thus generated.

The low but locally limited heat input during self-heating of the chip enables the production of soldered connections with the use of minimal amounts of solder paste. The dimensions of the sensor head, including the chip and the soldered wire ends, can thus be minimized.

The amount of solder paste per solder joint is preferably so small that the solder joint has little or no influence on the lateral dimensions of the sensor. The amount of solder paste depends on the dimensions of the chip and the wire and is preferably between 0.1 mg and 10 mg.

The soldered joints produced as described above have a very high strength. In particular, the strength of the soldered joints produced by self-heating is higher than that of conventional soldered joints, for the production of which heat is supplied from outside.

The strength of the soldered joint can also be adjusted very precisely. Preferably, the soldered joint can withstand a maximum tensile force of 6 N (Newton). Even more preferably, the soldered joint can withstand a maximum tensile force of 8 N or 10 N or more.

In one embodiment, the contacts between the chip and the contact points of the wires are formed by means of an electrically conductive adhesive. The conductive adhesive comprises, for example, a polymer material in which electrically conductive particles, e.g. metal particles of silver, are distributed.

In one embodiment, the contacts are formed using the smallest possible amount of adhesive.

The amount of adhesive is preferably so small that the adhesive has little or no influence on the lateral dimensions of the sensor. The amount of adhesive per contact depends on the dimensions of the chip and the wire and is preferably between 0.1 mg and 10 mg.

In one embodiment, the conductive adhesive is hardened by the self-heating of the NTC thermistor ceramic when an electrical voltage is applied.

As described above in relation to soldering, the electrical voltage can be applied to the chip via the wires and bridges of conductive adhesive that form. Applying an electrical voltage causes the NTC thermistor material to heat up.

Due to the low but locally limited heat supply, a firm connection between chip and wire can be produced with a minimal amount of adhesive.

According to one embodiment, a sensor head of the NTC sensor is encased in a polymer material. The sensor head comprises the chip and the contacts.

An encasing coating with a polymer material protects the sensor head, i.e. the chip with connected wires, from external mechanical, chemical or physical influences. The coating is preferably electrically insulating and not permeable to moisture.

The sensor head can comprise the chip, the contact points of the wires attached to it, the contacts between chip and wires, which are formed, for example, by solder or a conductive adhesive, and an encasing coating made of polymer material.

The encasing coating can be applied using various technologies, for example by immersion in a liquid polymer material, by covering a shrink tube or by melting a polymer powder applied to the sensor head in a fluidized bed.

Alternatively, the coating can also be obtained by immersing the sensor head in a polymer powder and then self-heating the chip in a similar way to soldering or hardening the adhesive. The latter process enables the formation of a particularly thin encasing coating that is formed with minimal material input, but encloses the sensor head without any gaps.

Alternatively, the encasing coating can be cured after application by self-heating of the chip and subsequent thermal treatment in an oven.

In one embodiment, the lateral dimension of the sensor head including the encapsulating polymer material in any direction perpendicular to the direction of extension of the wires is not more than twice the total dimension of the two wires in the same direction.

In one embodiment, the lateral dimension of the sensor head including the encasing polymer material in any direction perpendicular to the direction of extension of the wires is not greater than the total dimension of the two wires in the same direction.

Preferably, the diameter of one wire is no more than 0.3 mm and the sum of the two diameters is therefore no more than 0.6 mm.

Preferably, the wires run next to each other in a straight line. The two wires can be designed as a firmly connected double wire. The width of the two adjacent wires or a double wire consisting of two adjacent and connected wires in the direction of extension is therefore no more than 0.6 mm.

The width of the sensor head in the same direction perpendicular to the direction in which the wires extend is preferably no more than 1.3 mm, regardless of the diameter of the wires.

In the case of a double wire width of 0.6 mm, the width of the sensor head is preferably no more than 1.2 mm, more preferably no more than 1 mm and even more preferably no more than 0.8 mm.

In an advantageous embodiment, the sensor head is not wider than the double wire or the two parallel wires.

In a particularly advantageous embodiment, the width of the sensor head is approximately 0.6 mm or exactly 0.6 mm or less than 0.6 mm.

The dimension of the sensor head perpendicular to the direction of extension of the wires and perpendicular to the width is not more than 1.3 mm and preferably not more than 0.6 mm. Particularly preferably, the said dimension of the sensor head is not more than the wire diameter of 0.3 mm.

Due to the increasing miniaturization of electrical and electronic components and increasing automation, there is a growing need for sensors with very small dimensions that can be used in miniaturized components. The limiting factor here is usually the sensor head, which naturally has a larger dimension than the connecting wires.

By minimizing the dimensions of the sensor head, which then preferably no longer exceed the dimensions of the other wires, the entire sensor can be inserted into the electronic components simply by inserting the wires with the sensor head.

Possible areas of application are batteries and accumulators, for example in the automotive or industrial sectors.

Embodiments provide a method for manufacturing an NTC sensor. The NTC sensor produced according to the method may have all or some of the features described above in relation to the NTC sensor. Furthermore, the sensor described above may have all the features described below and may have been manufactured using the method described.

The process for manufacturing an NTC sensor comprises several steps.

In one step, two wires with contact points and a chip comprising an NTC thermistor ceramic are provided.

The chip is positioned at the contact points of the wires so that the maximum lateral dimension of the NTC sensor in any direction perpendicular to the direction in which the wires extend is less than the sum of the lateral dimensions of the chip and the wires.

In one embodiment, the maximum dimension of the NTC sensor is not larger than the dimension of the chip. In a preferred embodiment, the dimension of the chip is not larger than the dimension of the two wires in the same direction.

A mechanical connection and electrical contact between the chip and the wires is formed by soldering or by the application of conductive adhesive.

In one embodiment of the process, the connection between the chip and the wires is made by soldering.

In one embodiment, the heat required for soldering is provided by the self-heating of the NTC thermistor ceramic when an electrical voltage is applied.

For this purpose, the wires with solder paste applied to their contact points are brought into contact with the chip, preferably with the outer electrodes of the chip.

The solder paste can consist of various metals such as lead, tin, zinc, silver, copper, gold, antimony and bismuth. Preferably, the solder paste can be lead-free. Furthermore, the solder paste can be impregnated with a flux.

An electrical voltage is then applied to the chip via the wires. Applying the electrical voltage causes the NTC thermistor ceramic to heat up.

The self-heating of the chip causes the solder paste to melt and solidify during subsequent cooling.

The solder paste can be applied to the contact points of the wires, preferably by dipping the wires into a reservoir of solder paste. Alternatively, a dispenser can be used to apply a metered amount of solder paste to the contact points. The latter is particularly suitable if the contact points are not positioned at one end of the wire but, for example, at the side of the wire.

The low but locally limited heat input during self-heating of the chip enables the production of soldered connections with the use of minimal amounts of solder paste. The dimensions of the sensor head, including the chip and the soldered wire ends, can thus be minimized.

The soldered joints produced as described above have a very high strength. In particular, the strength of the soldered joints produced by self-heating is higher than that of conventional soldered joints, for the production of which heat is supplied from outside.

The strength of the soldered joint can also be adjusted very precisely. Preferably, the soldered joint can withstand a maximum tensile force of 6 N (Newton). Even more preferably, the soldered joint can withstand a maximum tensile force of 8 N or 10 N or more.

In one embodiment of the method, the connection and the electrical contact between the chip and the contact points of the wires are produced by a conductive adhesive. The conductive adhesive comprises a polymer material in which electrically conductive particles such as metal particles of silver are distributed.

In one embodiment of the process, the conductive adhesive is hardened by self-heating of the NTC thermistor ceramic when an electrical voltage is applied.

Applying an electrical voltage causes the NTC thermistor material to heat up. Due to the low but locally limited heat supply, a firm connection between the chip and wire can be created with a minimal amount of adhesive.

Preferably, the wire ends are briefly dipped into the adhesive in a first step so that some adhesive adheres to the contact points of the wires. The contact points of the wires are then placed on the outer electrodes or on the outer metallization of the chip and the chip is heated. For this purpose, electrical voltage can be applied to the chip via the wires and the material bridge made of conductive adhesive. The heating causes the thermosetting adhesive to harden, and a firm mechanical and electrically conductive connection is created between the wire and the chip.

In one embodiment of the process, the conductive adhesive is cured by irradiation with UV light. For this purpose, a UV-curable adhesive is used instead of a thermally curable adhesive. Otherwise, the procedure can be the same as in the previously described embodiment. An external UV radiation source is then required to cure the adhesive.

In one embodiment of the method, the wires are arranged in parallel. In this case, several contact points are formed along the wires by exposing the respective wire from an insulating sheath.

A chip is placed on each of the contact points and the wires are then cut between the individual chips to create several NTC sensors.

Using the process described, the chip can also be applied to the side of the wires and contacted. This is particularly useful for the series production of NTC sensors directly from a wire coil.

To do this, the wire coil is rolled out around a defined section. The contact points are then cut out of the insulating sheathing and the chips are applied to the contact points.

The wires between the chips are then cut to obtain the individual sensors. In order to be able to contact the chips with both wires, two adjacent contact points must be exposed on each of the two wires.

Preferably, the sheathing is removed so that the entire chip can be embedded in the remaining sheathing and rest directly on the two contact points. The entire chip can rest directly on the metal wires. In this embodiment, the sensor head has dimensions that do not or hardly exceed the dimensions of the chip.

In one embodiment, several chips are placed along the wires, which are arranged in parallel for this purpose, on several contact points formed along the wires and the wires are then cut between the individual chips so that several NTC sensors are obtained.

The wires are preferably arranged next to each other in a straight line for this purpose. One pair of contact points is arranged next to each other along the wires, one on each of the two wires. A chip can be arranged on each pair of contact points. Appropriately designed wires enable series production of the NTC sensors.

Wires can be two single wires lying next to each other, a double wire, or a partially unwound wire coil.

The invention is described in more detail below with reference to examples of embodiments and associated figures. Similar or apparently identical elements in the figures are marked with the same reference symbol. The figures and the proportions in the figures are not to scale. The invention is not limited to the embodiments shown in the figures.

### BRIEF DESCRIPTION OF THE DRAWINGS

FIG. 1 shows a first example of the NTC sensor;

FIG. 2 shows a first example of the NTC thermistor chip;

FIG. 3 shows a second example of the NTC sensor;

FIG. 4 shows a third example of the NTC sensor;

FIG. 5 shows a fourth example of the NTC sensor; and

FIG. 6 shows an example of an NTC sensor with a sheath.

### DETAILED DESCRIPTION OF ILLUSTRATIVE EMBODIMENTS

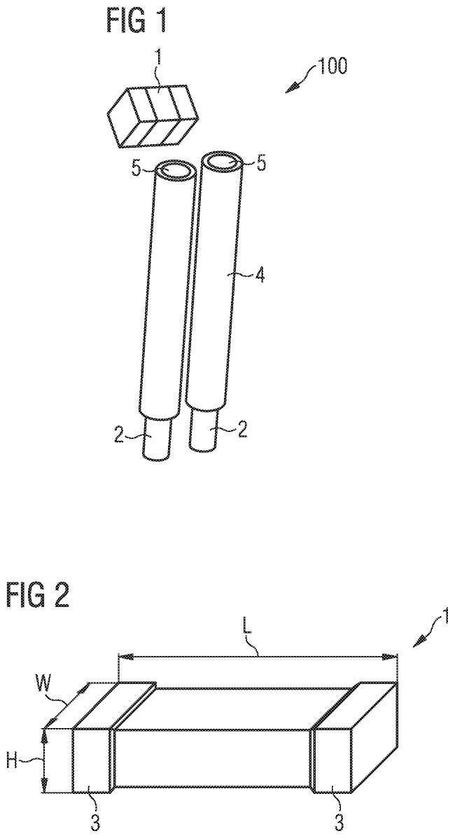

FIG. 1 shows a first example of the NTC sensor 100.

A chip 1 and two wires 2 are provided. Chip 1 comprises an NTC thermistor material. NTC stands for Negative Temperature Coefficient. This means that the thermistor material has a lower electrical resistance at higher temperatures (hot conductor).

The chip 1 is shown in FIG. 2 and has a cuboid structure. The chip measures a maximum of 0.6 mm in length L, 0.3 mm in width W and 0.33 mm in height H. The chip is electrically contacted at both ends in the longitudinal direction by outer electrodes 3. The outer electrodes 3 are preferably placed on the two ends in the longitudinal direction in the shape of a cap.

The outer electrodes 3 comprise metallization layers made of silver, for example, which are applied using an immersion process with subsequent baking. Ni—Sn layers can also be applied by electroplating.

In the embodiment example, the chip 1 is designed as a ceramic multilayer component with internal electrodes. A metallic inner electrode is arranged between every two ceramic layers. The inner electrodes are preferably electrically contacted alternately by the two outer electrodes 3.

The electrical resistance of such a multilayer component can be set very precisely. The resistance tolerance, i.e. the possible deviation of the resistance from a specified, desired electrical resistance at a nominal temperature, is less than 1%.

Alternatively, in an embodiment not shown here, the chip 1 can comprise a monolithic NTC ceramic block. The NTC ceramic block has no internal electrodes and is easy to manufacture. Outer electrodes 3 are applied to two opposite sides of the NTC ceramic block, which preferably cover the entire side surface of the ceramic block and via which the NTC ceramic block can be electrically contacted.

The wires 2 are, for example, silver-plated nickel wires, copper wires, stranded copper wires, Ni—Fe or Cr—Ni wires with Cu, Ag or Pt sheathing.

The wires 2 are preferably wrapped in an electrically insulating sheath 4. The sheath 4 consists of an electrically non-conductive polymer material such as perfluoroalkoxy alkane (PFA), Teflon, polyurethane (PU), polyamide (PA), polyimide (PI), silicone, polyester, polyacrylate, epoxy polymers, resins, or epoxy resins.

The two wires 2 have blunt ends 5 at their end faces, at which the electrically conductive wires are exposed. The blunt ends 5 thus represent contact points to which the chip 1 is attached.

There are several possible procedures for this.

According to a first exemplary process, the blunt ends 5 of the wires 2 are dipped into a solder paste and thus small amounts of solder paste are applied to the blunt ends 5 of the wires 2. The blunt ends 5 of the wires 2 are then arranged with the applied solder paste on the two opposing outer electrodes 3 of the chip 1.

An electrical voltage is then applied to chip 1 via the wires. When the electrical voltage is applied, chip 1 heats up and the solder paste melts. The flux in the solder paste is volatilized and the solder is hardened by subsequent cooling. Thus, a solder connection between the outer electrodes 3 and the contact points of the wires 2 is obtained exclusively by the self-heating of the chip 1 when an electrical voltage is applied.

The method described enables the application of the minimum amount of solder paste required to obtain a reliable connection between the chip 1 and the wires 2. The dimensions of the sensor head, which comprises the chip 1 and the connecting wires 2, can thus be minimized.

In an alternative method, the chip 1 is glued onto the contact points of the wires 2. To do this, the blunt ends 5 of the wires 2 are dipped into a thermosetting adhesive. The blunt ends 5 of the wires are then applied to the outer electrodes 3 of the chip 1. By applying an electrical voltage to the wires, the chip 1 is heated and the thermosetting adhesive is hardened.

In an alternative method, the chip 1 is also glued to the contact points of the wires 2. For this purpose, the blunt ends 5 of the wires 2 are dipped into a UV-curable adhesive. The blunt ends 5 of the wires 2 are then applied to the outer electrodes 3 of the chip 1. The adhesive is then hardened by irradiation with UV light.

The adhesive is electrically conductive. Examples of such adhesives are polymer-based adhesives that contain electrically conductive metallic particles such as silver particles. The method described enables the application of minimal amounts of adhesive to create the connection between chip 1 and wires 3, so that the dimensions of the sensor head can be minimized.

Furthermore, the geometry of the sensor head is optimized by a suitable dimension of the chip 1 and by an advantageous arrangement of the chip 1 on the wires 2.

Thus, in the present method, a chip 1 is used which is no longer than the sum of the two diameters of the two adjacent wires 2 and no wider than the diameter of one wire 2.

The length L is understood here and in the following as the dimension of the chip 1 between the two outer electrodes 3. This direction of expansion corresponds to the direction in which the two wires 2 lie next to each other.

The width W of chip 1 is referred to here and in the following as the perpendicular direction of expansion of the contact surfaces between chip 1 and wire 2. Height H here and in the following refers to the direction perpendicular to the contact surface.

Chip 1 is positioned here on the blunt ends 5 of the two adjacent wires 2. Due to the dimensions of the chip 1, it does not protrude beyond the wires 2 in either length or width. The sensor head is therefore no longer or wider than the remaining double wire 2.

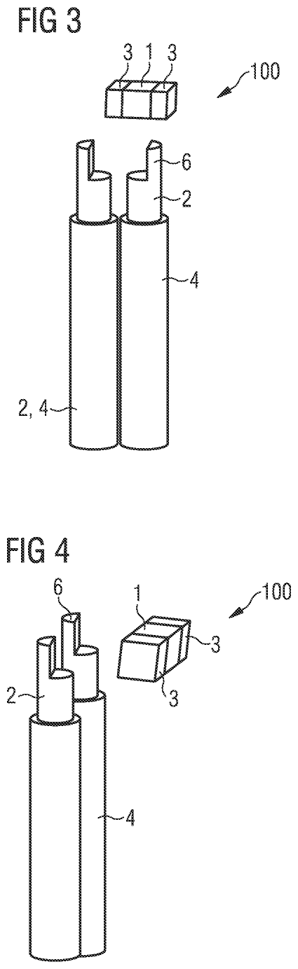

FIG. 3 and FIG. 4 show a second and third embodiment example of the NTC sensor 100. Features of the second and third embodiment examples, which correspond to the first embodiment example, are not explicitly described.

In contrast to the first embodiment example, the wires 2 in the second and third embodiment examples have L-shaped ends 6. The end faces of the wires are therefore not blunt but are shaped into a blade.

L-shaped here means that the wires 2 are flattened at their ends. The flat sections of the wires 2 therefore have a geometry that is similar to a shovel blade. The L-shaped ends 6 of the wires 2 can be applied laterally to the outer electrodes 3 of the chip 1. The L-shaped ends 6 have the advantage over the blunt ends 5 of the wires 2 that the contact surfaces between the wires 2 and the chip 1 are larger.

The L-shaped ends 6 of the wires 2 can either be placed on the cap-shaped outer electrodes 3 at two opposite ends, as shown in FIG. 3, or contact them from the same side, as shown in FIG. 4.

If both outer electrodes 3 are contacted from the same side, both outer electrodes 3 must be present on one side surface of the chip 1.

The exact arrangement depends primarily on practicability during production. The L-shaped ends 6 of the wires 2 have very small dimensions, which are negligible compared to the diameter of the non-flattened sections of the wires 2. Thus, even in the described arrangement of the second and third embodiment example, the sensor head has hardly any larger dimensions than the dimensions along the remaining double wire 2.

In the current design example, the contact surfaces between the wires and the chip can be made sufficiently large to achieve reliable contacting with low connection resistance.

The large contact surfaces also increase the mechanical stability of the sensor. If the chip is arranged between the wires as shown in FIG. 4, the mechanical stability of the sensor can be further improved.

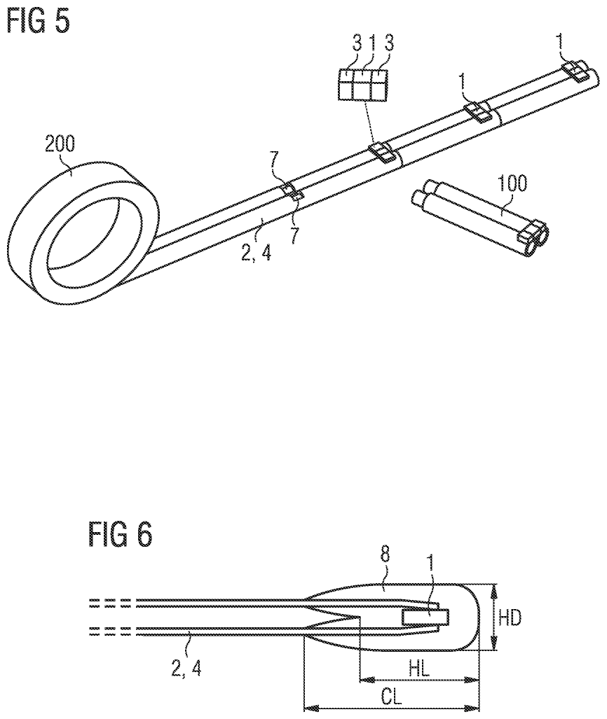

FIG. 5 shows a fourth embodiment example of the NTC sensor 100. Features of the fourth embodiment example, which correspond to the first embodiment example, are not explicitly described.

In contrast to the first embodiment example, the wires 2 in the fourth embodiment example are not yet cut to their final size but are present as a complete wire spool 200. Before the manufacturing process, a section of a defined length is unwound from the wire spool 200.

Contact points 7 are then exposed on the sides of the wires 2 by removing the insulating sheathing 4 at the contact points 7 up to the electrically conductive wire 2. Two adjacent contact points 7 are always exposed on both wires 2. In the embodiment example, the sheath 4 is preferably removed in such a way that the entire chip 1 can be applied directly to the wires 2 and the sensor head comprising the wires 2 and the chip 1 does not have unnecessarily large dimensions.

As in the previous embodiment examples, the chip 1 can be attached to the wires 2 both by gluing and soldering. For this purpose, small amounts of solder paste or adhesive are preferably applied to the exposed contact points 7 using a dispensing device. The chips 1 can then be applied to the contact points 7. By applying an electrical voltage, the connections to all the chips 1 applied to the wires 2 can then be soldered simultaneously or the adhesive can be cured simultaneously.

After the chips 1 have been completely applied, the double wires 2 with chips 1 are each cut between the chips 1 in order to obtain the desired individual sensors 100.

The process described can save work steps and simplify the mass production of chips 1.

Regardless of the embodiments described above, the sensor head is encased in a polymer material for protection against external mechanical influences, for protection against contamination, for protection against moisture and for electrical insulation.

FIG. 6 shows an exemplary NTC sensor with sheath 8. The dimensions of the sensor shown in FIG. 6 in the direction in which the wires HL and CL extend and the dimensions perpendicular to them are to be understood as examples only and do not necessarily correspond to the dimensions of the NTC sensor according to the invention.

The dimension HL here is the dimension of the sensor head from the wire ends in the direction in which the wires extend. The dimension CL is the dimension of the entire encasing coating 8 around the sensor head and the wires in the direction in which the wires extend. The dimension HD is the diameter of the rotationally symmetrical sheath in a direction perpendicular to the direction in which the wires extend.

The coating is carried out after the chip 1 is connected to the wires 2. The polymer material can be applied using various methods.

For example, the sensor head can be immersed in a reservoir of polymer powder and then heated by applying an electrical voltage. This melts the polymer powder and forms a thin encasing polymer coating around the sensor head. This process allows a very thin coating 8 to be formed and the dimensions of the sensor head can thus be further minimized.

Preferably, the lateral dimension of the sensor head HD including the encasing polymer coating 8 in any direction perpendicular to the direction of extension of the wires is not more than twice the total dimension of the two wires in the same direction and even more preferably not more than the total dimension of the two wires in the same direction.

In addition, thermal post-treatment in an oven can be carried out to increase the degree of hardening.

In an alternative process, the sensor heads are immersed in already liquefied polymer material to form the encasing coating 8. After immersion, the encasing coating 8 must be cured.

According to a third possible method, a shrink tube is placed over the sensor head and shrunk in the oven by applying heat. By selecting the shrink parameters, the shrinkage can be adjusted so that the sensor heads are completely and tightly encased.

In another process, a polymer powder is electrostatically charged and fluidized in a fluid bed by supplying a gas stream. The electrostatically charged powder particles adhere to the sensor head immersed in the fluid bed and can then be heated, melted, and subsequently cured in the oven.

All four methods described above enable the application of an advantageous thin polymer coating 8 to protect the sensor head.

In a mass production process, the encasing polymer coating can be applied around the sensor head before the individual NTC sensors 100 are separated by cutting the wires 2 from a wire spool 200.

1.-19. (canceled)

20. A NTC sensor comprising:
a chip;
two parallel wires, each wire having contact points; and
contact-connections between the chip and the contact points of each of the wires,
wherein a maximum lateral dimension of the NTC sensor in any direction perpendicular to a direction of extension of the wires is equal to or less than a sum of the lateral dimensions of the chip and the wires.

21. The NTC sensor according to claim 20, wherein the maximum lateral dimension of the NTC sensor s not greater than a lateral dimension of the chip in the same direction.

22. The NTC sensor according to claim 20, wherein the lateral dimension of the chip in any direction perpendicular to the direction of extension of the wires is not greater than a total dimension of the two wires in the same direction.

23. The NTC sensor according to claim 20, wherein the chip has a maximum lateral extension of 0.6 mm.

24. The NTC sensor according to claim 20, wherein the chip is a ceramic multilayer component with internal electrodes.

25. The NTC sensor according to claim 20, wherein the chip comprises a monolithic NTC thermistor ceramic.

26. The NTC sensor according to claim 20, wherein the two wires are in direct contact with each other.

27. The NTC sensor according to claim 20, wherein end faces of the wires act as contact points on which the chip is placed.

28. The NTC sensor according to claim 20, wherein contact points of the wires are L-shaped, and wherein the chip is placed on the L-shaped contact points.

29. The NTC sensor according to claim 20, wherein the contact points are formed by exposing the wire from an insulating sheath.

30. The NTC sensor according to claim 20, wherein the contact-connections are formed by a small amount of solder.

31. The NTC sensor according to claim 20, wherein contacts are formed by electrically conductive adhesive.

32. The NTC sensor according to claim 20, further comprising a sensor head encased by a polymer material, wherein the sensor head comprises the chip and the contact-connections.

33. The NTC sensor according to claim 32, wherein a lateral dimension of the sensor head including the encasing polymer material in any direction perpendicular to the direction of extension of the wires is not greater than twice a total dimension of the two wires in the same direction.

34. A method for manufacturing an NTC sensor, the method comprising:
providing two wires having contact points;
providing a chip comprising an NTC thermistor ceramic;
arranging the chip at the contact points of the wires so that a maximum lateral dimension of the NTC sensor in any direction perpendicular to a direction of extension of the wires is less than a sum of the lateral dimensions of the chip and the wires; and
forming a mechanical connection and an electrical contact between the chip and the wires by soldering or by applying conductive adhesive.

35. The method according to claim 34, wherein a heat required for soldering is provided by self-heating of the NTC thermistor ceramic when an electrical voltage is applied.

36. The method according to claim 34, wherein the conductive adhesive is cured by self-heating of the NTC thermistor ceramic when an electrical voltage is applied.

37. The method according to claim 34, wherein the conductive adhesive is cured by irradiation with UV light.

38. The method according to claim 34, further comprising:
arranging the wires in parallel;
forming a plurality of contact points along the wires by exposing the wires from an insulating sheathing;
placing a chip on each of the contact points; and
subsequently cutting the wires between the chips so that a plurality of NTC sensors are obtained.
